(19) United States
(12) Patent Application Publication
(10) Pub. No.: US 2012/0264029 A1
(43) Pub. Date: Oct. 18, 2012

(54) FUEL CELL SYSTEM

(75) Inventors: Yoshiyuki TAKAMORI, Hitachinaka (JP); Shinsuke Andoh, Hitachinaka (JP); Shuichi Suzuki, Hitachinaka (JP)

(73) Assignee: Hitachi, Ltd.

(21) Appl. No.: 13/445,950

(22) Filed: Apr. 13, 2012

(30) Foreign Application Priority Data
Apr. 14, 2011 (JP) 2011-089712

(51) Int. Cl. H01M 8/04; H01M 8/24

(52) U.S. Cl. 429/455

(57) ABSTRACT

A fuel cell system which suppresses a decrease in system efficiency of a fuel cell and, at the same time, allows an emission amount of harmful materials to be reduced for an extended period of time is disclosed. The fuel cell system includes a fuel cell stack generating electric power by chemical reaction between liquid fuel supplied to an anode and oxidant gases supplied to a cathode, and an exhaust mechanism discharging to an outside of the system exhaust gases discharged from the anode of the fuel cell stack, the exhaust mechanism being adapted to emit the exhaust gases into liquid in a tank storing the liquid fuel or water and, thereafter, discharge the exhaust gases to the outside of the system.

### FIELD OF THE INVENTION

The present invention relates to a fuel cell system which uses liquid fuel as fuel thereof to generate electric power.

### CLAIM OF PRIORITY

The present application claims priority from Japanese patent application serial no. 2011-089712 filed on Apr. 14, 2011, the content of which is hereby incorporated by reference into this application.

### BACKGROUND OF THE INVENTION

Information volume has been increased according to the recent progress in electronic technology. It is necessary to process the increased information at higher speed and with higher function, so that a power source having a high power density and a high energy density, namely, a power source whose continuous driving time is long is needed.

A demand for a small-sized power generator which does not require an electric charge, namely, a micro generator which can be easily fuelled has been increased. From such a background, the importance of the fuel cell has been considered.

Generally, a fuel cell includes at least a solid or liquid electrolyte, and an anode and a cathode which are a pair of electrodes for inducing desired electrochemical reaction, and is an electric power generator which directly converts chemical energy, which the fuel has into electrical energy with high efficiency.

Among such fuel cells, a fuel cell which uses a solid polymer electrolyte membrane as the electrolyte membrane and uses hydrogen as the fuel is referred to as a Polymer Electrolyte Fuel Cell (PEFC), and a fuel cell which uses methanol as the fuel is referred to as a Direct Methanol Fuel Cell (hereinafter referred to as DMFC). Especially, in DMFC, its liquid fuel has a high volume energy density so that the DMFC has received attention as an effective small-sized transportable or portable power source.

In the DMFC, methanol supplied to the anode is oxidized to generate carbon dioxide, and it is discharged. Moreover, methanol, passed through the solid polymer electrolyte membrane moves from the anode side to the cathode side and is oxidized by oxygen supplied to the cathode to generate, becomes carbon dioxide, and it is discharged. At least formic acid which is intermediate reaction product is formed in the methanol oxidization process and discharged from the fuel cell. Since the formic acid is harmful to the human body, an amount of the formic acid should be reduced as much as possible.

As a method for removing the formic acid, which is harmful materials discharged from the fuel cell, there is known a method in which a filter having a surplus gas absorbent is provided at exhaust gas piping, for example, as disclosed in Patent Literature 1. Moreover, there is known a method in which a filter including a cracking catalyst for the formic acid is provided at exhaust gas piping, as disclosed in Patent Literature 2.

### CITATION LIST

### Patent Literature

[Patent Literature 1] JP-A-2008-210796
[Patent Literature 2] JP-A-2005-183014

However, in the method where the absorbent is provided, there is the limitation of absorption capability of the absorbent, so it is difficult to obtain an effect of removal of the formic acid for an extended period of time. In the method, which employed the catalyst filter at the exhaust gas piping, the filter forms a flow resistance to flow-passage of exhaust gases, so the performance of a blower should be improved, and a loss becomes large due to auxiliary power and the efficiency of the fuel cell system is therefore reduced. Moreover, platinum or palladium is used as the cracking catalyst, there is a problem that the cost of the system is increased.

Accordingly, it is an object of the present invention to provide a fuel cell system which suppresses a decrease in system efficiency of a fuel cell and, at the same time, allows an emission amount of harmful materials to be reduced for an extended period of time.

### SUMMARY OF THE INVENTION

In accordance with the present invention, there is provided a fuel cell system which uses liquid fuel as fuel thereof to generate electric power, the fuel cell system comprising a fuel cell stack generating electric power by chemical reaction between liquid fuel supplied to an anode and oxidant gases supplied to a cathode, and gas exhaust means for discharging exhaust gases discharged from the anode of the fuel cell stack to an outside of the system, the gas exhaust means being adapted to emit the exhaust gases into liquid of a tank storing the liquid fuel or water, followed by discharging the exhaust gases to an outside of the system from the tank.

In the fuel cell system of the present invention, which is configured as discussed above, the exhaust gases containing harmful materials are discharged into the liquid fuel or water so that the harmful materials contained in the exhaust gases are dissolved in the liquid fuel or water. Thereby, the amount of the harmful materials to be discharged to the outside of the system can be remarkably reduced.

It is preferable that, in order that the harmful materials in the exhaust gases can be efficiently contacted with the liquid fuel or water, the exhaust gases discharged into the liquid are subjected to bubbling in such a manner that bubbles thereof become fine.

According to the present invention, it is possible to provide a fuel cell system which uses liquid fuel that does not need a filter or the like so that a decrease in system efficiency is suppressed and allows an emission amount of harmful materials to be reduced for an extended period of time.

### BRIEF DESCRIPTION OF DRAWINGS

FIG. 1 is a schematic diagram of a DMFC system according to an embodiment of the present invention;

FIG. 2 is a schematic diagram of an example of a water recovery tank section of the DMFC system of the present invention;

FIG. 3 is a schematic diagram of another example of the water recovery tank section of the present invention;

FIG. 4 is a schematic diagram of a DMFC system according to another embodiment of the present invention;

FIG. 5 is a schematic diagram of a DMFC system according to still another embodiment of the present invention; and

FIG. 6 is a schematic diagram of a conventional DMFC system.

### DETAILED DESCRIPTION OF THE PREFERRED EMBODIMENTS

Embodiments of the present invention will be discussed hereinafter.

### Embodiment 1

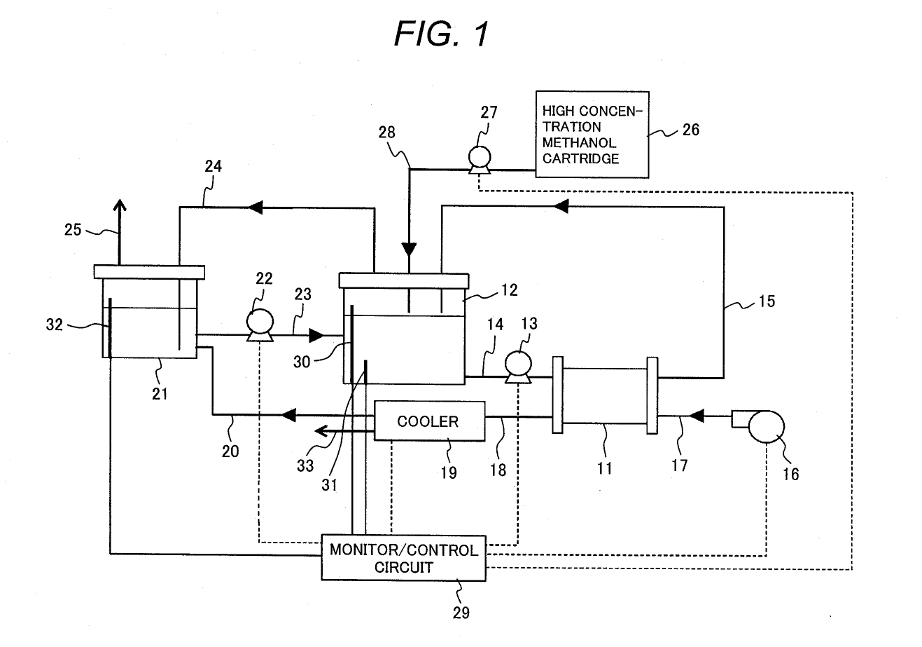

A fuel cell of the present invention which uses liquid fuel as fuel thereof to generate electric power will be explained hereinafter with reference to one example of a DMFC which uses methanol as the fuel. One example of a fundamental structure of the DMFC system is shown in FIG. 1. The DMFC system includes a stack 11 acting as an electric power generating section and formed by stacking single cells of a fuel cell, a fuel tank 12 and fuel pump 13 for supplying fuel to the stack 11 and recovering non-reacting residual fuel, a blower 16 for supplying air to the stack 11, a cooler 19 for cooling cathode exhaust and condensing water produced by electrochemical reaction in the stack 11, a water recovery tank 21 for recovering the water condensed in the cooler, a water level sensor 30 for detecting a decrease in the fuel due to fuel consumption in the fuel tank 12, a methanol concentration sensor 31 for detecting a methanol concentration in the fuel tank 12, and a monitor/control circuit 29 for monitoring the water level sensor 30 and the methanol concentration sensor 31 and for performing the system controls of operating and stopping a high concentration methanol supply pump 27 for supplying high concentration methanol to the fuel tank 12 from a high concentration methanol cartridge 26, and a water supply pump 22 for supplying water to the fuel tank 12 from the water recovery tank 21.

The stack 11 is formed by stacking a plurality of single cells in series, each of which comprises a membrane electrode assembly (MEA), in which an anode and a cathode are formed so as to interpose a solid polymer electrolyte membrane therebetween, and a separator supplying the fuel and oxidant gas to the anode and the cathode. A methanol solution which is the fuel, and air which is the oxidant gas, or oxygen are supplied to the stack 11, whereby generation of electric power is performed.

In the anode, methanol oxidation reaction expressed by the following formula (1) progresses and, in the cathode, oxygen reduction reaction expressed by the following formula (2) progresses. In the methanol oxidation reaction progressing in the anode, a side reaction by which at least formic acid is produced as indicated by the following formula (3) occurs. Portions of the formic acid is discharged together with CO₂ exhaust gases produced by oxidation of the methanol to the outside of the fuel cell system. Since the formic acid is harmful to the human body, a formic acid emission amount is required to be reduced as much as possible.

CH₃OH+H₂O→CO₂+6H⁺+6e⁻ (1)

3/2O₂+6H⁺+6e⁻→3H₂O (2)

CH₃OH+H₂O→HCOOH+4H⁺+4e⁻ (3)

The fuel cell system according to this embodiment has a feature residing in that, in order to reduce the amount of the emission of the formic acid to the outside of the DMFC, exhaust gases which contain the formic acid and have returned together with the non-reacting fuels to the fuel tank 12 from the anode are not discharged directly to the outside of the fuel cell system and are discharged to the outside of the fuel cell system from an exhaust port 25 provided at the water recovery tank 21, after the exhaust gases are subjected to bubbling in recovered water accumulated in the water recovery tank 21 and the formic acid in the exhaust gases are dissolved into the recovered water. Concretely, the fuel tank 12 of this system has a sealed structure which does not allow the exhaust gases, containing the formic acid and having returned to the fuel tank 12, to be discharged directly to the outside of the system.

Pressure within the fuel tank 12 rises according to increase of gas phase components (exhaust gases). Due to the pressure, the exhaust gases pass through a fuel-exhaust-gas line 24 connecting the fuel tank 12 and the water recovery tank 21 and are discharged into the recovered water in the water recovery tank 21. Thereby, many formic acid in the exhaust gases are dissolved into the recovered water, so that an amount of the formic acid to be discharged to the outside of the fuel cell system can be considerably reduced. Incidentally, the recovered water in which the formic acid have been dissolved is supplied to the fuel tank 12 as necessary by the drive of the water supply pump 22 on the basis of measured values which the monitor/control circuit 29 receives from the water level sensor 30 and the methanol concentration sensor 31. Portions of the formic acid having dissolved in the fuel of the fuel tank 12 are oxidized in the stack 11 and contribute to the generation of electric power, so that improvement of electric power generation efficiency and improvement of fuel utilization can be expected.

Moreover, the fuel cell system according to the present invention is configured as a system which recovers water from cathode exhaust gases. The methanol which has passed through the cathode from the anode via the electrolyte membrane is reacted in the manner expressed by the above-mentioned formula (3), whereby a small quantity of formic acid is also produced in the cathode. When the water is recovered from the cathode exhaust gases, portions of the formic acid contained in the cathode exhaust gases are also recovered. Therefore, the system which recovers the water from the cathode exhaust gases also contributes to the reduction in the amount of the formic acid to be discharged to the outside of the system.

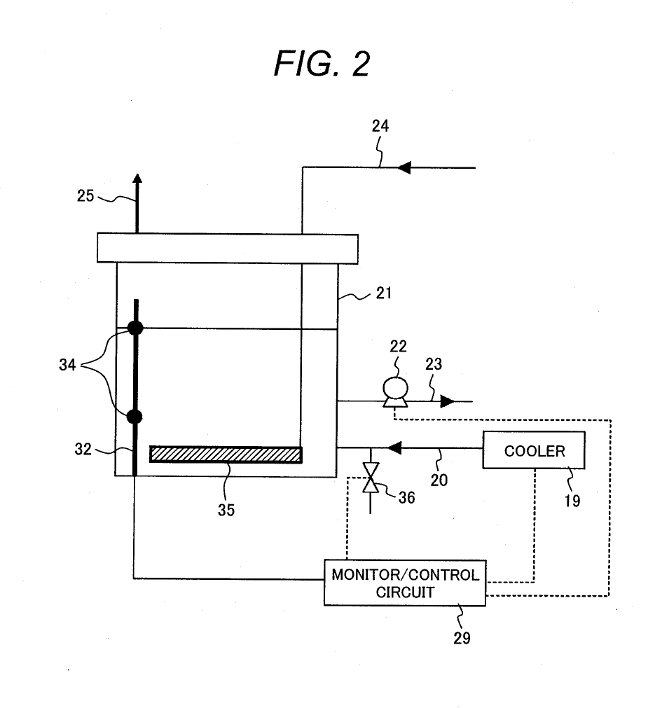

FIG. 2 illustrates one example of the water recovery tank section of the system according to the present invention. A water level sensor 32 is attached to the water recovery tank 21. The upper limit and lower limit of the water level in the water recovery tank 21 are detected via floats 34 for detection of the water level. In order that the water level becomes falling in this range, the monitor/control circuit 29 controls cooling capability of the cooler 19 to increase or decrease a recovering amount of the water or performs a control in such a manner to discharge extra water from a drain valve 36 or the like.

The exhaust gases which have been sent to the water recovery tank 21 from the fuel-exhaust-gas line 24 are discharged into the recovered water from a fuel-exhaust-gas bubbling section 35 which is provided at a position lower than the lower limit of the water level in the water recovery tank 21. In order that the exhaust gases and the water are efficiently contacted with each other at this time, the fuel-exhaust-gas bubbling section 35 preferably has a structure which allows bubbles of the exhaust gases to become fine. The exhaust gases from which the formic acid have been removed by bubbling in the recovered water are discharged to the outside of the fuel cell system from the exhaust port 25. Incidentally, it is preferable that the sections such as the fuel-exhaust-gas line 24, the fuel-exhaust-gas bubbling section 35, and the water recovery tank 21 which contact the fuel-exhaust-gases and the recovered water are made of any suitable materials which are resistant to the formic acid.

Moreover, if temperature of the recovered water is low, recovery efficiency of the formic acid in the fuel-exhaust-gases is improved, so that the recovered water is desirably cooled, by the cooler 19, to a temperature which is not more than 60° C. and, more preferably, is not more than 40° C. In order that the recovered water in the water recovery tank 21 is kept at a low temperature, a cooling mechanism may be provided at the water recovery tank 21. Moreover, in order to avoid an increase in the temperature of the recovered water due to heat build-up of the stack 11, any heat insulating material may be provided between the water recovery tank 21 and the stack 11. For example, thermal insulation can be achieved by covering a circumference of the water recovery tank 21 or a circumference of the stack 11 with any heat insulating material.

### Embodiment 2

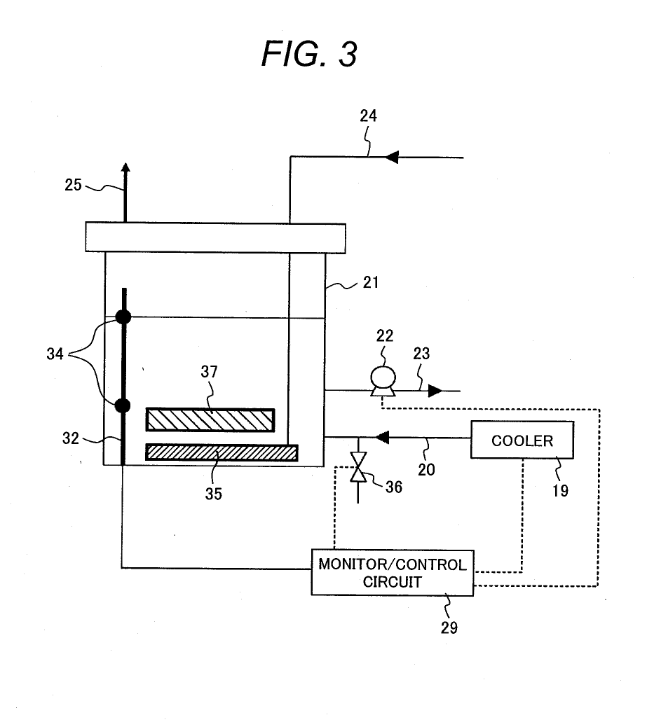

FIG. 3 illustrates another example of the water recovery tank section according to the embodiment. This example has a feature residing in that an ion exchanging resin layer 37 is provided in the water recovery tank 21. Except the provision of the ion exchanging resin layer 37, this embodiment has the same system structure as the embodiment shown in FIG. 2 has. The ion exchanging resin layer 37 is provided in the water recovery tank 21, whereby the formic acid which have dissolved into the recovered water in the water recovery tank 21 are removed by the ion exchanging resin layer and the formic acid concentration in the recovered water is therefore kept low. Therefore, efficiency of dissolution of the formic acid in the fuel-exhaust-gases into the recovered water is increased and the amount of the formic acid to be discharged to the outside of the fuel cell system can be more reduced.

While the ion exchanging resin layer 37 is provided in the water recovery tank 21 in this embodiment, the ion exchanging resin layer 37 may be provided at a water supply line 23 which supplies the water to the fuel tank 12 from the water recovery tank 21.

### Embodiment 3

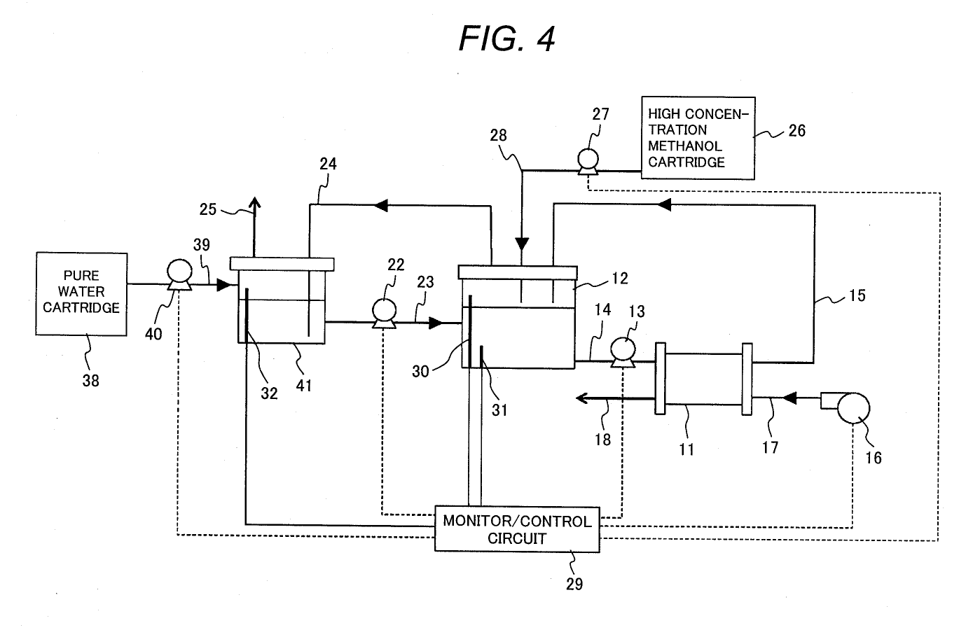

FIG. 4 illustrates another embodiment of the DMFC system according to the present invention. This fuel cell system is one example which does not have a system which recovers the water generated in the stack 11. The DMFC system includes a stack 11 acting as an electric power generating section, a fuel tank 12 and fuel pump 13 for supplying fuel to the stack 11 and recovering residual fuel, a blower 16 for supplying air to the stack 11, a water level sensor 30 for detecting a decrease in the fuel due to fuel consumption in the fuel tank, a methanol concentration sensor 31 for detecting a methanol concentration in the fuel tank, and a monitor/control circuit 29 for monitoring the water level sensor 30 and the methanol concentration sensor 31 and for performing the system controls of operating and stopping a high concentration methanol supply pump 27 for supplying high concentration methanol to the fuel tank 12 from a high concentration methanol cartridge 26, a pure water cartridge 38 for supplying water to a water tank 41, and a water supply pump 22 for supplying the water to the fuel tank 12 from the water tank 41.

This embodiment has a feature residing in that, in order to reduce the amount of the formic acid to be emitted to the outside of the DMFC system, exhaust gases which contain the formic acid and have returned together with residual fuel to the fuel tank 12 are not discharged directly to the outside of the fuel cell system and are discharge to the outside of the fuel cell system from an exhaust port 25 provided at the water tank 41, after the exhaust gases are subjected to bubbling in the water accumulated in the water tank 41 and the formic acid in the exhaust gases are dissolved into the water. Thereby, many of the formic acid in the exhaust gases dissolve into the recovered water, so that the amount of the formic acid to be discharged to the outside of the fuel cell system can be considerably reduced.

### Embodiment 4

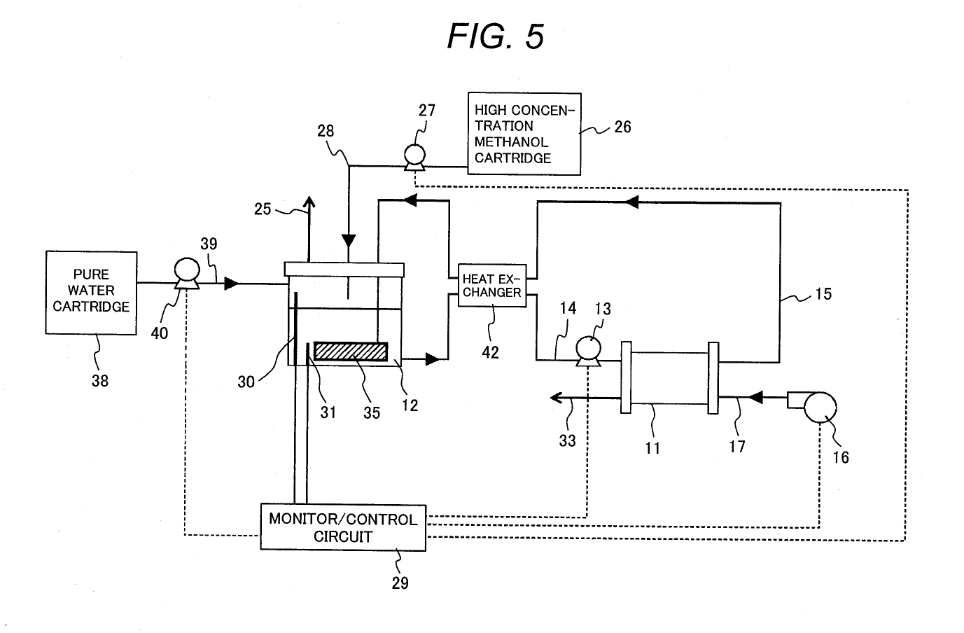

FIG. 5 illustrates still another embodiment of the DMFC system according to the present invention. According to this fuel cell system, exhaust gases which contain formic acid and have returned together with non-reacting fuel to a fuel tank 12 are subjected to bubbling in the fuel tank 12 after temperature of the exhaust gases is lowered via a heat exchanger 42, whereby the formic acid is dissolved into the fuel in the fuel tank 12 and the amount of the formic acid to be discharged to the outside of the fuel cell system is reduced. The DMFC system according to this embodiment includes a stack 11 acting as an electric power generation section, a fuel tank 12 and fuel pump 13 for supplying the fuel to the stack 11 and recovering non-reacting fuel, a blower 16 for supplying air to the stack 11, a water level sensor 30 for detecting a decrease in the fuel due to fuel consumption in the fuel tank 12, a methanol concentration sensor 31 for detecting a methanol concentration in the fuel tank,

and a monitor/control circuit 29 for monitoring the water level sensor 30 and the methanol concentration sensor 31 and for performing the system controls of operating and stopping a high concentration methanol supply pump 27 for supplying high concentration methanol to the fuel tank 12 from a high concentration methanol cartridge 26, a pure water cartridge 38 for supplying water to the fuel tank 12, and a pure water supply pump 40 for supplying the water to the fuel tank 12 from the pure water cartridge 38. Moreover, the DMFC system of this embodiment includes a heat exchanger 42 for performing a heat-exchange between the fuel and non-reacting fuel containing exhaust gases.

This embodiment has a feature residing in that, in order to reduce the amount of the formic acid to be emitted to the outside of the DMFC, exhaust gases which contain the non-reacting fuel and the formic acid is subjected to bubbling in the fuel in the fuel tank 12 by a fuel-exhaust-gas bubbling section 35 after the exhaust gases are allowed to pass through the heat exchanger 42, to thereby lower their temperature, the formic acid in the exhaust gases are dissolved into the fuel of the fuel tank 12, and the exhaust gases in which a formic acid concentration has been decreased are discharged to the outside of the fuel cell system from an exhaust port 25 which is provided at the fuel tank 12.

In a DMFC system which does not have the heat exchanger, the temperature of the fuel in the fuel tank 12 rises to the substantially same temperature as the stack 11 by heating the fuel due to the electric power generation in the stack 11 and, even if the exhaust gases containing the formic acid is subjected directly to the bubbling in the fuel of the fuel tank 12, the formic acid in the exhaust gases are not efficiently absorbed into the fuel and most of the formic acid is discharged to the outside of the fuel cell as it is.

On the other hand, if the heat exchanger 42 for performing the heat-exchange between a fuel supply line 14 and a fuel recovery line 15 is provided in the manner as in this embodiment and the heat exchange between fuel before being introduced into the stack 11 and non-reacting fuel before leaving the stack 11 is performed, the fuel in the fuel tank 12 can be kept at a low temperature close to an ambient temperature. Thereby, most formic acid in the exhaust gases can dissolve into the fuel and the amount of the formic acid to be discharged to the outside of the fuel cell system can be considerably reduced.

Moreover, the fuel cell system according to this embodiment employs the structure which performs the heat exchange between the fuel and the non-reacting fuel containing the exhaust gases by the heat exchanger 42, to thereby provide the following advantages. The fuel in the fuel tank 12 is kept at the temperature lower than the temperature of the stack 11 in order to enhance the solubility of the formic acid in the exhaust gases. On the other hand, if low-temperature water is supplied to the stack 11, the power generation by the stack 11 may be adversely affected by the low-temperature fuel, for example, output is made unstable. On the contrary, in this system, the fuel which is supplied to the stack 11 from the fuel tank 12 is heated by the heat exchanger 42, whereby the problem encountered in the case where the low-temperature fuel is supplied to the stack 11 is solved.

### Comparative Example

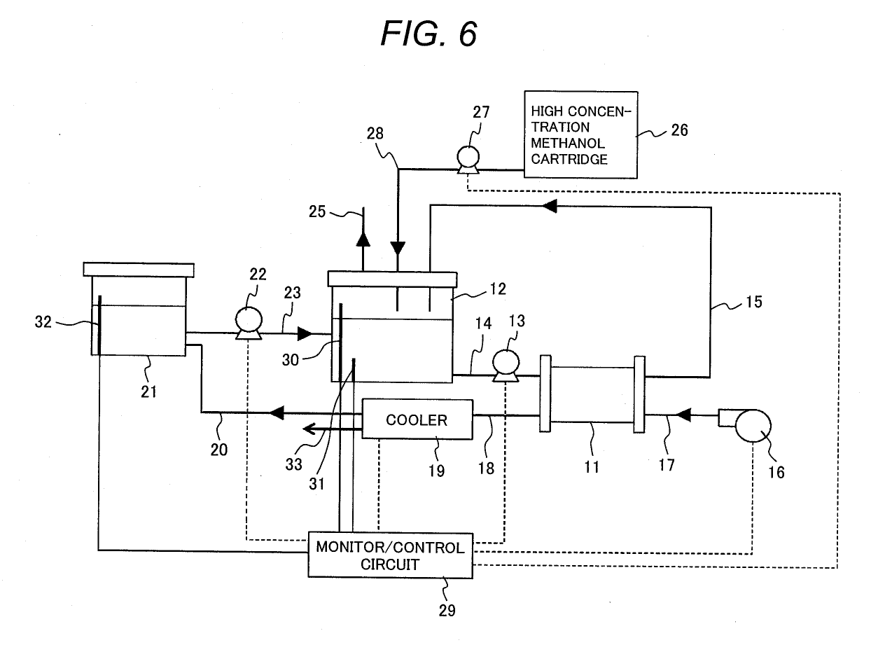

FIG. 6 is a schematic diagram of a DMFC system of the prior art. The conventional system has a structure in which exhaust gases that contain formic acid and have returned together with non-reacting fuel to a fuel tank 12 are discharged directly to the outside of the system from an exhaust port 25 which is provided at the fuel tank 12.

### Evaluation

The above-mentioned respective embodiments and the comparative example were operated under the same conditions and the emission amounts of the formic acid were estimated. The evaluation requirements are as follows: the respective DMFC systems were set on a place having an ambient temperature of 25° C., the external load was set to 100 W, they were operated for one hour, the exhaust gases which are discharged from the exhaust ports were collected in a state where the operations of the systems are steady, and the amounts of the formic acid contained in the collected exhaust gases were measured by an ion chromatography. In all systems, the methanol concentration in the fuel tanks was controlled so as to become 3±0.5 wt %. When the evaluation was performed, the embodiment 1 in which the cooling mechanism for the water recovery tank 21 and the heat insulating material were not provided was employed.

Incidentally, the water temperatures of the water recovery tanks 21 and water tanks 41 of the embodiments 1-3 were measured. All the temperatures were in the range of 35° C. to 38° C.

The evaluation results are shown in Table 1 below. Incidentally, the measurement results of the emission amounts of the formic acid is based on a case where the emission amount of the formic acid in the comparative example is standardized as 1.

TABLE 1

| | Emission amount of formic acid |
|---|---|
| DMFC system | (—) |
| Comparative Example | 1 |
| Embodiment 1 | 0.12 |
| Embodiment 2 | 0.08 |
| Embodiment 3 | 0.11 |

As compared with the formic acid-emission amount in the DMFC system of the comparative example, the formic acid-emission amount in the embodiment 1 was reduced to about ⅛ and the formic acid-emission amount in the embodiment 2 was reduced to about 1/12, namely, the least amount of the formic acid-emission. Moreover, the formic acid-emission amount in the embodiment 3 was reduced to about 1/9.

As described above, by the application of the DMFC systems according to the present invention, it is possible to considerably reduce the amount of the formic acid to be emitted from the fuel cell systems.

Incidentally, while the present invention has been described with reference to the specific embodiments of the DMFCs employing the methanol as the fuel thereof, the present invention can be also applied to a fuel cell employing different liquid fuels, such as a direct ethanol fuel cell. The direct ethanol fuel cell produces acetaldehyde and acetic acid as intermediate formations in the ethanol oxidation reaction progressing in the anode. Acetaldehyde is harmful to the human body. So the emission amount of the acetaldehyde is required to be reduced as much as possible. Acetic acid is not harmful to the human body, but it has pungent smell. So the emission amount of the acetic acid is also required to be reduced as much as possible. Both acetaldehyde and acetic acid dissolve in water, so the present invention can be applied to a direct ethanol fuel cell. The present invention is not limited to the DMFC.

The present invention relates to the fuel cell system which uses the liquid fuel as the fuel thereof to generate the electric power. The present invention can be applied to fuel cell systems such as DMFCs and direct ethanol fuel cells, and electronic equipment having these fuel cells carried therein as power sources.

What is claimed is:

1. A fuel cell system which uses liquid fuel as fuel thereof to generate electric power, the fuel cell system comprising:
a fuel cell stack generating electric power by chemical reaction between liquid fuel supplied to an anode and oxidant gases supplied to a cathode; and
gas exhaust means discharging to an outside of the system exhaust gases discharged from the anode of the fuel cell stack; wherein
the gas exhaust means discharges the exhausted gases into liquid in a tank storing the liquid fuel or water, followed by discharging the exhaust gases to the outside of the system from the tank.

2. The fuel cell system according to claim 1, wherein the gas exhaust means is adapted to cause the exhausted gases to be bubbled in the liquid.

3. A fuel cell system which uses liquid fuel as fuel thereof to generate electric power, the fuel cell system comprising:
a fuel cell stack generating electric power by chemical reaction between liquid fuel supplied to an anode and oxidant gases supplied to a cathode;
a fuel tank storing the liquid fuel to be supplied to the fuel cell stack;
a water tank storing water to be supplied to the fuel tank;
a non-reacting fuel recovery line returning non-reacting fuel, which contains exhaust gases discharged from the anode of the fuel cell stack, to the fuel tank; and
a fuel-exhaust-gas line causing the exhaust gases in the fuel tank to flow into the water tank;
wherein the exhaust gases are discharged into the liquid of the water tank from the fuel-exhaust-gas line and discharged to an outside of the system from an exhaust port which is provided at the water tank.

4. The fuel cell system according to claim 3, wherein the fuel tank is sealed.

5. The fuel cell system according to claim 3, wherein the exhaust gases are discharged into the liquid in the water tank from a bubbling section of the fuel-exhaust-gas line.

6. The fuel cell system according to claim 3, wherein an ion exchanging resin layer is provided in either the water tank or a water supply line supplying the water in the water tank to the fuel tank.

7. The fuel cell system according to claim 3, further including a water recovery section recovering water from the exhaust gases discharged from the cathode of the fuel cell stack, wherein the water recovered by the water recovery section is supplied to the water tank.

8. The fuel cell system according to claim 3, further including a heat insulating material between the fuel cell stack and the water tank.

9. A fuel cell system which uses liquid fuel as fuel thereof to generate electric power, the fuel cell system comprising:
a fuel cell stack generating electric power by chemical reaction between liquid fuel supplied to an anode and oxidant gases supplied to a cathode;
a fuel tank storing the liquid fuel to be supplied to the fuel cell stack;
a non-reacting fuel recovery line returning non-reacting fuel, which contains exhaust gases discharged from the anode of the fuel cell stack, to the fuel tank; and
a heat exchanger provided at the non-reacting fuel recovery line for cooling the non-reacting fuel containing the exhaust gases; wherein
the exhaust gases is discharged into liquid in the fuel tank from the non-reacting fuel recovery line and discharged to an outside of the system via an exhaust port which is provided at the fuel tank.

10. The fuel cell system according to claim 9, wherein the heat exchanger is adapted to perform a heat-exchange between the non-reacting fuel containing the exhaust gases discharged from the anode, and the fuel supplied to the fuel cell stack from the fuel tank.

11. The fuel cell system according to claim 9, wherein the exhaust gases are discharged in the liquid in the fuel tank from a bubbling section of the non-reacting fuel recovery line.
